(19) United States
(12) Patent Application Publication
(10) Pub. No.: US 2007/0258767 A1
(43) Pub. Date: Nov. 8, 2007

(54) FIBERGLASS MATS AND ASSEMBLIES THEREOF

(76) Inventor: Robert Timothy Tapp, Washington, DC (US)

Correspondence Address: PERMAN & GREEN, 425 POST ROAD, FAIRFIELD, CT, 06824, US

(21) Appl. No.: 11/670,310

(22) Filed: Feb. 1, 2007

Related U.S. Application Data
(60) Provisional application No. 60/765,254, filed on Feb. 3, 2006.
(60) Provisional application No. 60/883,629, filed on Jan. 5, 2007.

(51) Int. Cl. E01C 5/00; B32B 17/06; B32B 17/10; B32B 3/06

(52) U.S. Cl. 404/36; 135/144; 404/44; 404/70; 427/136; 428/426; 428/430; 428/99

(57) ABSTRACT

A portable ground matting system that has at least one fiberglass mat and at least one fastener. The at least one fiberglass mat has a fiberglass layer with at least one roving and a resin disposed on the roving. The fastener removably fastens the fiberglass mat to a ground surface so that the fiberglass mat mats the ground surface. When loads are disposed on the matted ground surface so that the loads load the fiberglass mat, the fiberglass mat operates between the loads and ground surface to redistribute the loads to the ground surface and prevent substantial permanent deformation of the ground surface.

### CROSS-REFERENCE TO RELATED APPLICATION(S)

This application claims the benefit of U.S. Provisional Application No. 60/765,254, filed Feb. 3, 2006 and Application No. 60/883,629, filed Jan. 5, 2007, incorporated by reference herein in its entirety.

### FIELD

The disclosed embodiments relate to structural, foldable fiberglass mats and assemblies thereof.

### BACKGROUND

There is a desire for structural systems that are portable and capable of rapid erection to form temporary, semi-permanent or permanent structures that may be employed as self-standing structures or may be combined with other structures to enhance or restore those structures. For example, automobiles, airplanes, and helicopters may generally use surfaces for roads and runways that are smooth and stable. However, construction, environmental conditions including catastrophic disasters, and damage from munitions and ballistics (e.g. impact or over pressure) can destabilize these surfaces, create holes or craters, or completely eliminate these surfaces. Other examples are structures or support surfaces that may be desired and built to support an expected loaded condition that turns out to be lower than the actual loads to be applied to the structure (e.g. paved surfaces in way of trailer parking). Various pad or sheet-like materials have been developed for use as temporary covers or patches for holes or cracks in concrete, asphalt or macadam surfaces in roads and runways. In addition, methods and materials have been developed for rapid construction of temporary surfaces to be used as roads and runways.

Users of heavy construction equipment often need to use ground cover mats when moving their equipment across lawns, mud and other soft terrain in order to avoid damage to the terrain by the equipment and/or to prevent the equipment from becoming immobilized by the terrain. Typical ground cover mats are made from plywood, aluminum, steel or fiberglass reinforced materials. For example, U.S. Pat. No. 5,807,021 discloses a ground cover mat manufactured from recycled plastic that includes a pattern of lugs on its upper and lower surfaces to provide traction for the vehicle and friction for the terrain. The ground cover mat is used to protect the terrain from damage and to provide a traction surface for automobiles.

Current methods of repairing or patching holes or trenches created in roadways for the purpose of repair or access to utilities are expensive, labor intensive, and hazardous to vehicular traffic. For example, the holes can be filled with compacted aggregate material to the level of the road surface. However, this aggregate material can erode from the hole or undergo additional compaction under the weight of vehicular traffic. The result can be a significant pothole that is a hazard to automobiles and an impedance to traffic flow. Placing an asphalt cap over the compacted aggregate may not entirely alleviate the problems as compaction and subsequent pothole formation are still possible. Another commonly used cover material is a large, heavy gauge steel plate. Such plates require heavy equipment to hoist them into place, have sharp raised edges and in some instances are fastened with raised hold-down clips that are hazards to vehicles, are slippery when wet or icy, and create significant noise as automobiles cross over them.

Although airport runways are constructed of the same materials as roadways and can be subjected to the same type of environmental hazards and repairs, airfields are also common bombing targets during times of war. Once damaged or destroyed, rapid emergency repairs are required to avoid or to minimize interruption of operations. Aluminum planks have been used for surfacing of expeditionary airfields and for rapid runway repair. For example, U.S. Pat. No. 3,379,104 describes a landing mat formed of interlocking sections. Each mat section is a hollow aluminum panel having a honeycomb construction inside and filled with premolded blocks of polyurethane. Similarly, U.S. Pat. No. 3,557,670 discloses an aluminum panel assembly for bridging bomb craters in runways and pavements. These aluminum planks, however, are difficult to produce and are expensive, and also present a bump profile, which causes overstressing of critical components of aircraft, which must traverse bomb craters in runways surfaced over with such matting.

Other landing mats utilizing fiberglass reinforced plastic laminates have been produced as a lighter weight alternative to aluminum. For example, U.S. Pat. No. 4,629,358 uses portable panels of fiberglass reinforced plastic composite mats, which use hollow inorganic silica spheres in the plastic resin to reduce weight. In order to cover larger areas or entire runways, multiple panels are joined together. Recessed lips are provided along the edges of the mats to provide for interconnection of the mats. Assembling and connecting multiple mats is time consuming, and creates an excessive number of joints along the runway both parallel and perpendicular to the path of travel. In addition, the thinner recessed lip portions of the panel create areas where failure or cracking of the mats is more likely.

U.S. Pat. No. 4,404,244 also describes a membrane of fiberglass-reinforced polyester resin as a trafficable cover over a compacted backfilled crater. Single piece mats are produced and cut to the desired size to cover the crater. Craters having diameters larger that 40 feet are repaired using a double membrane method wherein an additional membrane is placed below the surface membrane at a debris and crushed stone interface. This additional membrane is created in the field by cutting and placing the fiberglass as required and spraying with polyester resin. This resin has to sufficiently set-up before crater repair proceeds. This system requires a significant amount of labor and time for larger applications as two layers of membrane are required with one being formed in the field.

In addition to providing landing surfaces for fixed-wing aircraft, mats have been used to provide landing surfaces for helicopters. Depending on the type of materials used and the assembly and deployment of these materials, rapidly deployed and portable helicopter landing pads can suffer from the same shortcomings as runway repair materials. For example, U.S. Pat. No. 3,616,111 is directed to a plastic landing pad made of interconnected panels. Each panel is constructed of top and bottom fiberglass lamina surrounding an inner core lamina that is a non-woven organic fiber mat. The upper and lower surfaces of the panels include interlocking recesses so that the mats can be layered, interlocked, and stapled together to form a landing pad. The assembly of this landing pad is time consuming, and due to its thickness and method of assembly is unlikely to be suitable for runway crater repairs.

### SUMMARY OF THE EXEMPLARY EMBODIMENTS

In accordance with a first exemplary embodiment a portable ground matting system is provided. The system comprises at least one fiberglass mat and at least one fastener. The at least one fiberglass mat has a fiberglass layer with at least one roving and a resin disposed on the roving. The fastener removably fastens the fiberglass mat to a ground surface so that the fiberglass mat mats the ground surface. When loads are disposed on the matted ground surface so that the loads load the fiberglass mat, the fiberglass mat operates between the loads and ground surface to redistribute the loads to the ground surface and prevent substantial permanent deformation of the ground surface.

In accordance with another exemplary embodiment a relocatable ground cladding system is provided. The ground cladding system is adapted to cover and at least partially clad a supporting ground surface. The system comprises a movable structural cladding layer and removable fasteners. The structural cladding layer is movable and has at least one fiberglass mat. The fasteners are adapted for coupling the movable structural cladding layer to the supporting ground surface. The removable fasteners are removably fastened to the supporting ground surface to removably couple the movable structural cladding layer to the supporting ground surface so that the movable structural cladding layer clads the supporting ground surface at a first location.

In accordance with another exemplary embodiment a portable shelter is provided. The portable shelter comprises a foldable fiberglass mat. The mat has a plurality of fiberglass mat sections, a plurality of hinges connected to the mat sections. Each hinge is disposed between two adjacent fiberglass mat sections to form a single foldable shelter. The mats have a folded position for use in storing and shipping the shelter and an expanded position for storage and protection of objects or persons placed within the shelter.

### BRIEF DESCRIPTION OF THE DRAWINGS

The foregoing aspects and other features of the exemplary embodiment are explained in the following description, taken in connection with the accompanying drawings, wherein:

FIG. 1 is a cross-section of an embodiment of the fiberglass mat;

FIG. 2 is a cross-section of another embodiment thereof;

FIG. 3 is a plan view of an embodiment of the fiberglass mat;

FIG. 4 is a plan view of an embodiment of an assembly of fiberglass mats;

FIG. 5 is a plan view of an embodiment of a joining panel;

FIG. 6 is a plan view of another embodiment of a joining panel;

FIG. 7 is a cross-section of an embodiment of a bushing for use with the joining panel;

FIG. 8 is a plan view of an embodiment of a foldable fiberglass mat;

FIG. 9 is a view through line 9-9 of FIG. 8;

FIG. 10 is a perspective view of the foldable fiberglass mat in a folded position; and

FIG. 11 is a cross section view of an apparatus for making hinges for the foldable fiberglass mat;

FIG. 12 is a cross-section of the fiberglass mat deployed on a road surface;

FIG. 13 is a cross-section of an anchor bushing used with the fiberglass mat; and

FIG. 14 is a cross-section of the fiberglass mat in an alternative deployment on a road surface.

FIG. 15 is a plan view of a foldable fiberglass mat in accordance with another exemplary embodiment, the mat being shown in an unfolded position;

FIG. 16 is a schematic perspective view of the mat in a folded position;

FIG. 17 is another schematic view of the mat folded to form a structure in accordance with another exemplary embodiment in accordance with another exemplary embodiment;

FIG. 18 is a cross-section view of a structural system with the foldable fiberglass mat arranged for construction of another structure in accordance with another exemplary embodiment;

FIG. 19 is a cross-section of the system with the fiberglass mat arranged for construction of another structure in accordance with another exemplary embodiment;

FIG. 20 is a cross-section of fiberglass mat deployed as cladding for a supporting surface in accordance with yet another exemplary embodiment;

FIG. 21 is a top view of fiberglass mat deployed as cladding for a supporting surface, and a load structure TRL positioned on the cladding; and

FIG. 22 is an isometric view of a kit having fiberglass mat for deployment as cladding for a supporting surface.

### DETAILED DESCRIPTION

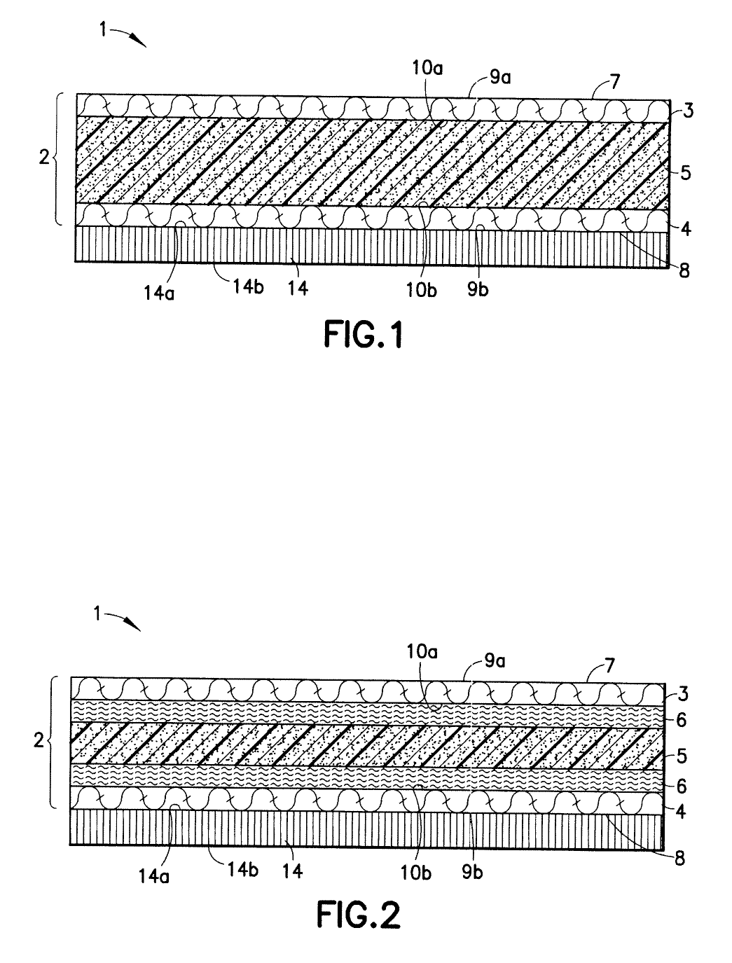

Referring initially to FIG. 1, there is shown an exemplary embodiment of a system including the fiberglass mat 1 that has at least one fiberglass layer 2 containing for example a first woven roving 3, a second woven roving 4, and a polyester resin 5. Although the embodiments will be described with reference to the embodiments shown in the drawings, it should be understood that the present invention can be embodied in many alternate forms of embodiments. In addition, any suitable size, shape or type of elements or materials could be used.

Referring still to FIG. 1, the fiberglass mat 1 of the exemplary embodiment includes at least one fiberglass layer 2 containing a first woven roving 3, a second woven roving 4, and a polyester resin 5. Suitable woven rovings may include for example glass Type E woven rovings having a Silane binder. The woven rovings may for example, have a weight of about forty ounces per square yard, an input single end roving 113 yield in warp and 56 yield in weft, a 4×2 construction, a glass distribution of about 50% in warp and about 50% in weft and tied lenos. Suitable polyester resins include for example those that are a thermosetting, low-pressure, laminating type. For example, the woven rovings 3, 4 may be Glass Type E, and the polyester resin 5 may be 155-7990 resin, commercially available from the Eastman Chemical Company of Kingsport, Tennessee. The woven roving may for example have an average weight of from about 38 up to about 44 ounces per square yard. In the exemplary embodiment shown, the woven roving may have a weight of about 40.8 ounces per square yard. The fiberglass layer 2 may include additional woven rovings or additional or alternative resins or mixtures of resins to impart additional structural strength or other properties to the fiberglass layer 2. In alternate embodiments, the fiberglass may have any other desired configuration, and may have more or fewer rovings and resin layers of any desired materials.

In order to impart desired qualities such as increased strength to the fiberglass mat, the fiberglass layer 2, in the exemplary embodiment, may further include additives such as chopped fiber layers, additional or alternative fibers, ultraviolet light inhibitors, and coloring agents. As is best shown in FIG. 2, the chopped fibers are included, for example in fiber layers 6 that are stitched (though in alternate embodiments the chopped fibers may be connected to the rovings in any other desired manner) to the first and second woven rovings 3,4. For example, chopped fibers may weigh from about 1.5 to about 2.5 ounces per square foot. For example, the chopped fibers may weigh about 2 ounces per square foot.

Additional or alternative fibers in the fiberglass layer 2 may include a plurality of polyamide fibers. In one embodiment, the polyamide fibers are aramid, para aramid or aromatic polyamide fibers. For example, the aromatic polyamide is poly para-phenyleneterephthalamide. Poly para-phenyleneterephthalamide is available under the brand name KEVLAR® from E.I. du Pont de Nemours and Company of Wilmington, Del. A desired amount of aromatic polyamide fibers may be added to provided increased rigidity and structural strength to the fiberglass layer 2 and hence the fiberglass mat 1. A desired amount of aromatic polyamide fibers may be added to make the fiberglass layer resistant to impact by ballistic projectiles such as bombs, artillery shells, shrapnel, and bullets. The aromatic polyamide fibers can be disposed in one or more locations throughout the fiberglass layer 2. Suitable locations include for example, at least one of the first and second woven rovings, the chopped fiber layers 6, throughout the fiberglass layer 2, or in one or more independent fiber layers or woven fiber layers internal to the fiberglass layer 2. Alternatively, the aromatic polyamide fibers may be included in a separate layer external to the fiberglass layer 2 (not shown) and attached to either the top 7 or the bottom 8 of the fiberglass layer 2 to form the fiberglass mat 1.

To assemble the fiberglass layer 2 for example, the first and second woven rovings 3,4 may be cut to size, aligned and spaced apart from each other. The alignment and spacing of the first and second woven rovings 3,4 may be arranged to provide the desired final thickness of the fiberglass layer, the desired strength of the fiberglass mat 1, and the space desired for additional layers or additives within the fiberglass layer 2. For example, the woven rovings are arranged so that the fiberglass layer will have a thickness sufficient to support the forces or loads imposed upon the top 7 of the fiberglass mat 1 and to be portable and suitable for applications where a low profile is desirable, for example roads, aircraft runways or other similar roll on surfaces. Suitable thicknesses for example may include about ⅛ inch up to about 5 inches or from about 0.2 inches up to about 2 inches. In one embodiment, the thickness is from about ¼ inch up to about 1 inch. In another embodiment, the fiberglass mat 1 has a thickness of about 0.2 inches. In another embodiment, each fiberglass layer 2 is constructed to have sufficient strength so that at a thickness of about 0.2 inches, it can support the weight of vehicular traffic or a fully loaded cargo plane. In another embodiment, the thickness of the fiberglass layer 2 is about ⅜ inch. In an alternative embodiment, the fiberglass layer 2 has a thickness such that it is flexible enough to be rolled up upon itself.

The spacing between the first and second woven rovings 3,4 can also be made suitable for the insertion of additional woven rovings. For example, additional woven rovings may be included in the fiberglass layer 2 between the first and second woven rovings 3,4. In general, the first and second woven rovings 3,4 may be placed so that the first woven roving 3 is disposed substantially adjacent to the top 7 of the fiberglass layer 2 and the second woven roving 4 may be disposed adjacent to the bottom 8 of the fiberglass layer 2.

In the exemplary embodiment illustrated in FIG. 2, with one or more chopped fiber layers 6 included in the fiberglass layer 2, the first and second woven rovings may for example be each stitched or otherwise connected to chopped fiber layers 6 before being aligned, spaced and set within the fiberglass layer 2. In alternate embodiments formation of the fiberglass mat may be accomplished in any other desired manner. The first woven roving 3 has an outer face 9a and an inner face 10a, and second woven roving 4 also has an outer face 9b and an inner face 10b. In the exemplary embodiment, the chopped fiber layers 6 may be attached to the inner faces 10a,b. After being attached to the chopped fiber layers 6, the first and second woven rovings 3, 4 may be placed so that their respective outer faces 9 correspond to the top 7 and bottom 8 of the fiberglass layer 2.

The polyester resin 5 is added for example to the first and second woven rovings 3,4 and any additional layers of woven rovings or chopped fiber layers 6 in an amount sufficient to saturate all of the layers of fiberglass reinforcement material internal to the fiberglass layer 2 including the first and second woven rovings 3,4 and to fill any space between the first and second woven rovings 3,4. A suitable ratio by weight of resin to internal reinforcement material, including the woven rovings and chopped fiber layers 6, may be for example from about 60:30 up to about 40:50. In one embodiment, the ratio of resin to reinforcement material may be about 50:50, and in another embodiment, the ratio may be about 55:45. After application of the polyester resin, the fiberglass layer 2 is allowed to cure and dry before being cut to the desired size or shaped, or otherwise further processed.

The cured and dried fiberglass layer 2 may either be further processed by the attachment of additional layers, custom cut to the desired size for an application, processed into standard sheets for custom cutting on location just prior to application or processed into assemblies of fiberglass mats. As is shown in FIGS. 1 and 2, the fiberglass mat 1 includes one or more reinforcement layers 14 attached to the fiberglass layer 2.

In the exemplary embodiment the reinforcement layer 14 may be constructed from materials and is shaped to impart increased structural rigidity and strength to the fiberglass layer. For example, the reinforcement layer 14 may be attached to the bottom 8 of the fiberglass layer 2 so that upon an application of the fiberglass mat 1 where the reinforcement layer 14 is in contact with the ground, the reinforcement layer 14 inhibits or prevents movement of the fiberglass mat 1 with respect to the ground and inhibits or minimizes erosion or shifting of the ground under the fiberglass mat 1. In one embodiment, the reinforcement layer 14 is a prefabricated reinforcing composite capable of providing increased rigidity and stability to the fiberglass layer 2. Suitable prefabricated reinforcing composites include for example a resin-impregnated, semi-rigid, open grid of continuous multi-filament reinforcing strands. In the exemplary embodiment the grid may be formed of continuous filament rovings of fiberglass although other fibers having a similar modulus can be used for example fibers of poly para-phenyleneeterephthalamide. The open grid is arranged to include square or rectangular openings having side lengths for example up to about 6 inches (though the side lengths may have any desired size). In order to create a semi-rigid reinforcing composite that is rigid enough to provide the desired increased stability and rigidity but flexible enough to be rolled, the open grid may be coated for example with a resin. Suitable resins include for example asphalt, rubber modified asphalt, unsaturated polyesters, vinyl ester, epoxy, polyacrylates, polyurethanes, polyolefines, and phenolics, which give the required rigidity, compatibility, and corrosion resistance. They may be applied using hot-melt, emulsion, solvent, or radiation-cure systems or any other desired application system or method. One curing system used for a coating and found satisfactory was thermally cured. Suitable thicknesses for the reinforcement layer 14 may be for example the same as those for the fiberglass layer 2. The reinforcement layer 14 may be included in the overall thickness of the fiberglass layer 2.

The reinforcement layer 14 may be attached to either the top 7, the bottom 8, or both the top and the bottom of the fiberglass layer 2 (FIG. 2 shows the reinforcing layer 14 on the bottom for example purposes only). Suitable methods for attaching the reinforcement layer 14 to the fiberglass layer 2 include for example bonding, gluing, attaching with fasteners such as screws and bolts, and forming integral with the fiberglass layer 2. In one embodiment, the reinforcement layer 14 may include an adhesive on either the top 14a, bottom 14b, or both the top 14a and bottom 14b of the reinforcement layer 14. The adhesive may be selected to be capable of binding the reinforcement layer 14 to the surface to which the mat 1 is applied. Suitable adhesives include for example synthetic elastomeric adhesives and synthetic thermoplastic adhesives. Included among these are acrylics, styrene-butadiene rubbers, tackified asphalts, and tackified olefins. Examples of suitable reinforcing composites for use in the reinforcement layer 14 can be found in U.S. Pat. Nos. 4,699,542, 4,957,390, 5,110,627, and 5,393,559 and the entire discloses of which are incorporated herein by reference.

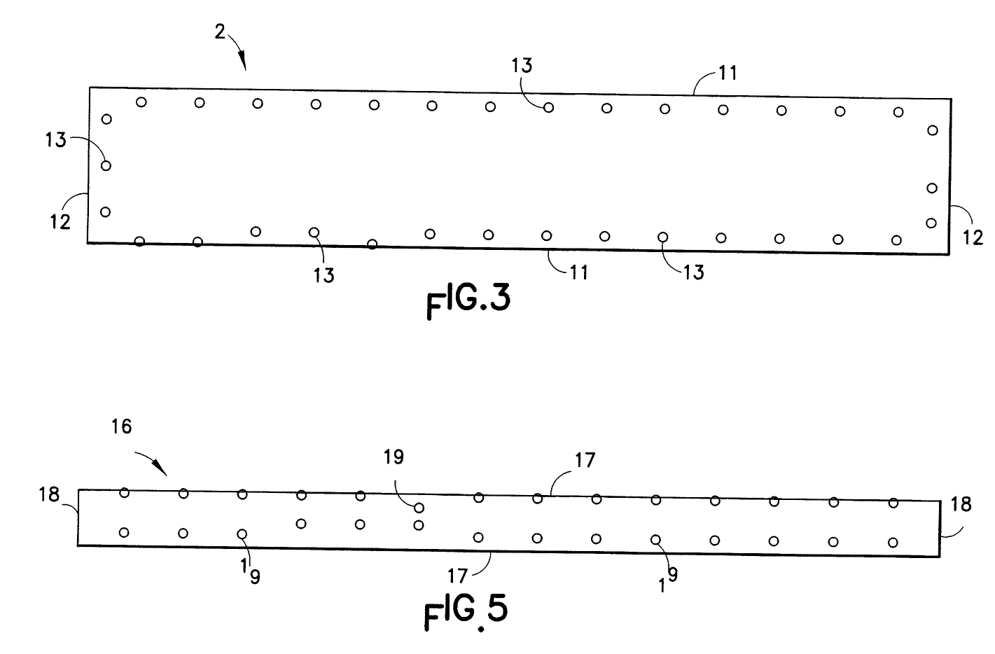

Although the fiberglass layer 2 may be cut into any desired shape, as is best shown in FIG. 3, the fiberglass layer 2 may be for example generally rectangular in shape when processed into sheets. For example, the fiberglass layer 2 may include a first pair of opposing sides 11 and a second pair of opposing sides 12. For example, in one embodiment, each of the first pair of opposing sides 11 may have a length of about 10 feet up to about 30 feet, and each of the second pair of opposing sides 12 may have a length of about 1 foot up to about 10 feet. For example, the first sides 11 may be about 30 feet long, and the second sides 12 may be about 6 feet long. Additional layers, such as the reinforcement layer 14 may be for example either shaped similar to the fiberglass layer 2, or may be attached to the fiberglass layer 2 first and then shaped when the fiberglass layer 2 is shaped. In alternate embodiments, the layers may have any desired shape.

In the exemplary embodiment, the fiberglass layer 2 may also include a plurality of holes or slots 13 that pass completely through the fiberglass layer 2. The holes 13 are provided and sized to accept fasteners (not shown) that may be used for example to secure together multiple fiberglass layers 2 or to anchor the fiberglass layer 2 to a surface or to aid in transport and placement of the mats. Suitable fasteners include arrangements of bolts, nuts, washers, or any other desired fasteners. A sufficient number of holes 13 are provided as needed for adequate attachment or anchoring of the fiberglass layer 2. In the example shown, the plurality of holes 13 are disposed in a row that runs generally parallel to and adjacent to the first and second pairs of opposing sides 11,12, although the holes 13 may be distributed in various patterns throughout the fiberglass layer 2. In the exemplary embodiment, fourteen holes 13 are aligned in a row adjacent to both of the first pair of opposing sides 11, and three holes are aligned in a row adjacent to both of the second pair of opposing sides 12. In alternate embodiments, any other desired fastener pattern may be used with more, or fewer or no through fastener holes. In the exemplary embodiment, the reinforcement layer 14 may also includes a plurality of holes or slots passing completely through the reinforcement layer 14 that can be used to anchor the reinforcement layer to the ground or other suitable anchoring surface. One or more of the holes may be aligned with the holes 13 in the fiberglass layer 2 and can be used for securing the reinforcement layer to the fiberglass layer 2. In the exemplary embodiment, the reinforcement layer 14 contains the same number and pattern of holes as found in the fiberglass layer 2. In alternate embodiments, the reinforcement layer may have more or fewer holes and may have a different hole pattern. As may be realized, FIG. 3 also represents a top or bottom view of the fiberglass mats.

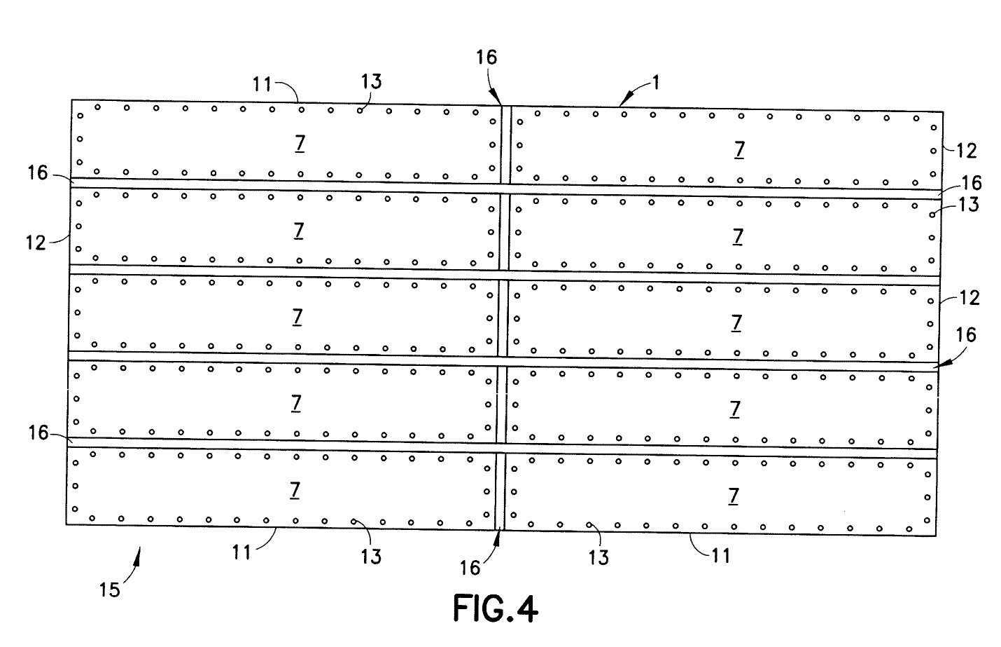

As is shown in FIG. 4, the fiberglass mat 1 may be included in an assembly of multiple fiberglass mats 15. Any number of fiberglass mats 1 may be combined into an assembly. For example, an assembly of fiberglass mats can include at least two of the fiberglass mats joined together on either the first or second pairs of opposing sides. In the example shown, ten fiberglass mats are arranged in a fiberglass mat assembly 15. Although all of the fiberglass mats 1 shown are substantially similar in size and shape, the fiberglass mats 1 in the assembly 15 may vary in size, shape, or thickness. In the embodiment shown, each fiberglass mat 1 in the assembly is generally rectangular in shape and includes first and second opposing sides 11,12 that are of substantially similar length to facilitate arrangement and assembly. The matching first and second opposing sides 11, 12 can then be butted up against each other to form the fiberglass mat assembly 15 shape desired. In alternate embodiments, differently shaped mats may be joined together in the assembly. In order to secure the fiberglass mats 1 together in the assembly 15, adjacent fiberglass mats 1 can be overlapped so that holes 13 in the mats align. Fasteners are then passed through the holes. Alternatively, the adjacent fiberglass mats can be sealed together using fiberglass reinforcement materials and polyester resin. The mats may be joined together using a plurality of joining panels 16.

In the exemplary embodiment, each joining panel 16 is attached to the sides of both of the adjacent fiberglass mats 1 between which it is disposed. When all of the joining panels 16 are attached to their respective fiberglass mats 1, the single unitary mat assembly 15 is formed. Various materials including for example metals, polymers and elastomers are suitable to be used as joining panels. Each joining panel 16 may be constructed of the same materials as the fiberglass mat 1. The joining panels 16 can have the same thicknesses, additives, structures, and cross-sections and have the same variety of sizes, shapes, and thicknesses as the fiberglass mat 1 in general and the fiberglass layer 2 in particular. In one embodiment, each joining panel 16 includes first and second woven rovings spaced from each other and a polyester resin to saturate the first and second woven rovings and to fill the space between the first and second woven rovings.

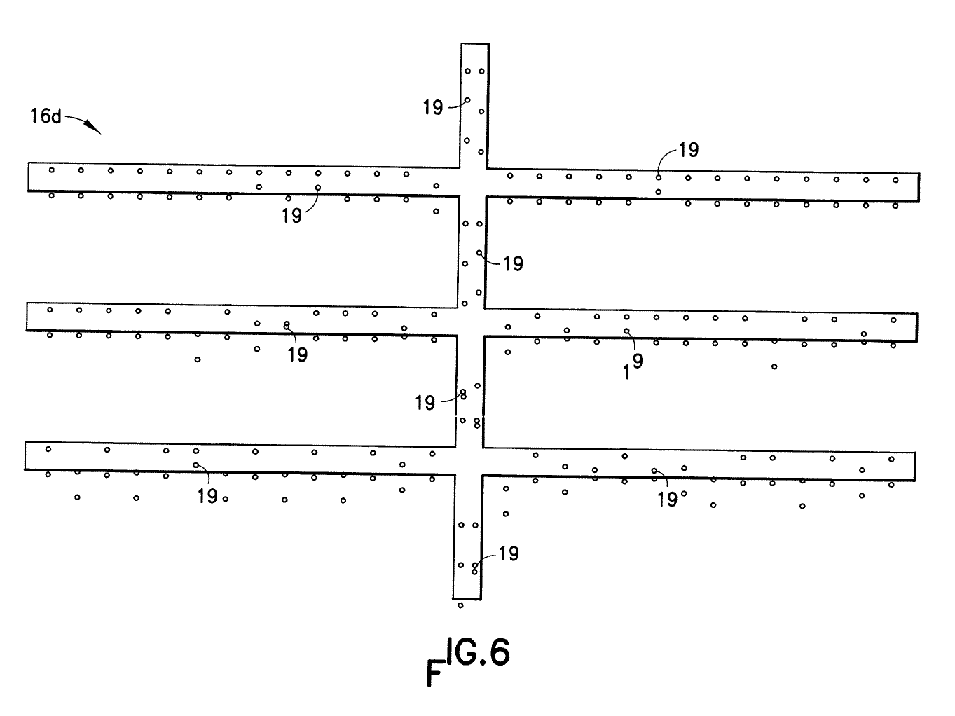

As is shown in FIG. 5, in one exemplary embodiment each joining panel 16 is generally rectangular in shape and includes at least one first pair of opposing edges 17 that have a length substantially equal to at least one of the first and second pairs of opposing sides of the fiberglass mats 1 to which that joining panel 16 is attached. In alternate embodiments, the joining panels may have any desired shape. Suitable lengths for the opposing edges of the joining panels include any custom length and nominal lengths such as 1 foot, 5 feet, 10 feet, and 100 feet. In the exemplary embodiment, the joining panel edges may have a length such as either 24 feet or 30 feet. Multiple joining panels 16 can be used along the length of either the first or second pairs of opposing sides 11,12 (of one panel) or of multiple opposing sides. A second pair of opposing edges 18 can have lengths similar to the first pair of opposing edges 17. In the exemplary embodiment, the length of each second opposing edge 18 may be minimized so that adjacent fiberglass mats 1 in the assembly 15 are joined as closely together as desired. As shown in FIG. 4, other suitable shapes for the joining panels 16 include “IL” shapes and cross “+” shapes. In the exemplary embodiment shown in FIG. 6, the joining panel 16d may take the shape of a grid that defines the overall size and shape of the assembly of fiberglass mats 15 (or a subportion thereof). Construction of the assembly for example would involve placement of the grid-type joining panel in the desired location and attachment of the fiberglass mats 1 to the joining panel 16.

The joining panels 16 may be secured to the fiberglass mats 1 by any of the methods used to join the fiberglass mats 1 together directly. In the exemplary embodiment, each joining panel 16 may include a plurality of holes or slots 19 passing completely through the joining panel 16. Although these holes may be located anywhere desired throughout the joining panel, the holes 19 in the illustrated embodiment may be generally disposed along the first pair of opposing edges 17 and arranged to substantially align with the plurality of holes 13 in the fiberglass mat 1. In the exemplary embodiment, holes may also be provided along the second pair of opposing edges 18 for attachment to the fiberglass mat 1 or anchoring to a surface or the ground. For the rectangular arrangement of joining panels, the plurality of holes for example are arranged in a row disposed along and adjacent to the opposing edges and are of an equal number to the corresponding holes 13 in the fiberglass mat 1. In alternate embodiments, more or fewer holes may be provided. The joining panels 16 and fiberglass mats 1 are secured together by passing a fastener through each one of the aligned pairs of holes 13, 19.

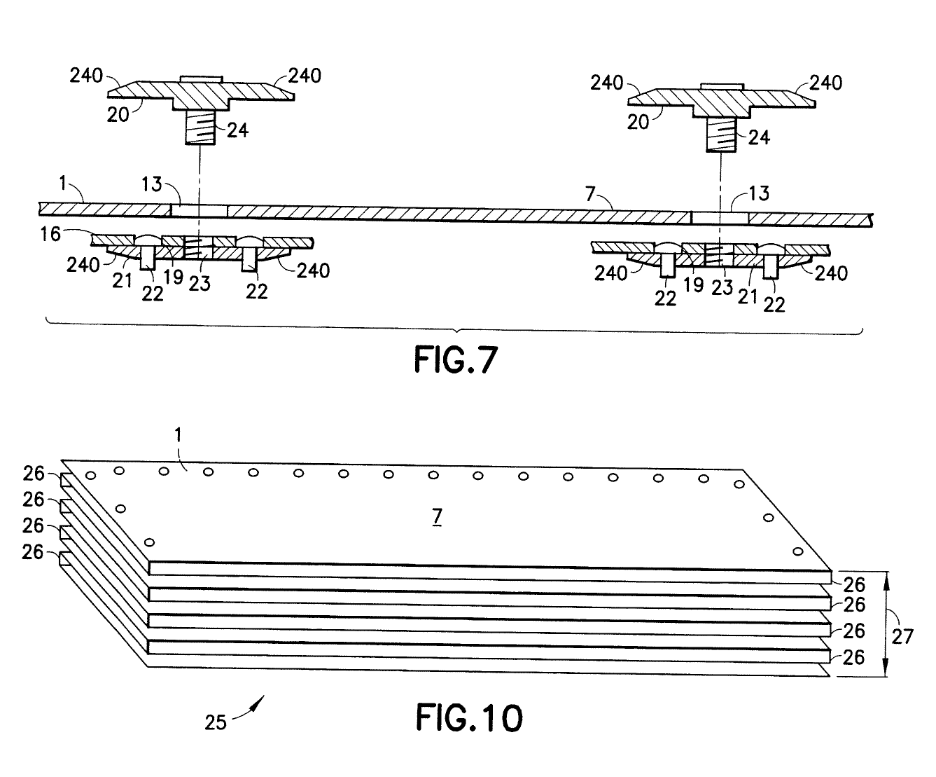

As is shown in FIG. 7, in the exemplary embodiment suitable fasteners for use in the assembly of fiberglass mats 15 may also include upper joining bushings 20 and lower joining bushings 21 to protect the holes from tearing or elongating and to provide for a more secure attachment between the fiberglass mat 1 and the joining panel 16 especially under the forces to which the assembly 15 is subjected. In the exemplary embodiment shown, the lower joining bushings 21 are disposed in and around the joining panel holes 19 and are secured to the joining panel 16 by a plurality of rivets 22. The lower joining bushings 21 include a central threaded hole 23. The upper joining bushing 20 passes through the holes 13 in the fiberglass mat and includes a threaded shaft 24. Both joining bushings include a tapered edge 240 to minimize interference with wheels when the assembly 15 is in use. In order to attach the fiberglass mat 1 to a joining panel 16 containing the lower joining bushings 21, the holes 13, 19 are aligned and the upper joining bushing 20 is threaded into the lower joining bushing 21. Suitable materials for the bushings include stainless steel and zinc plated metals.

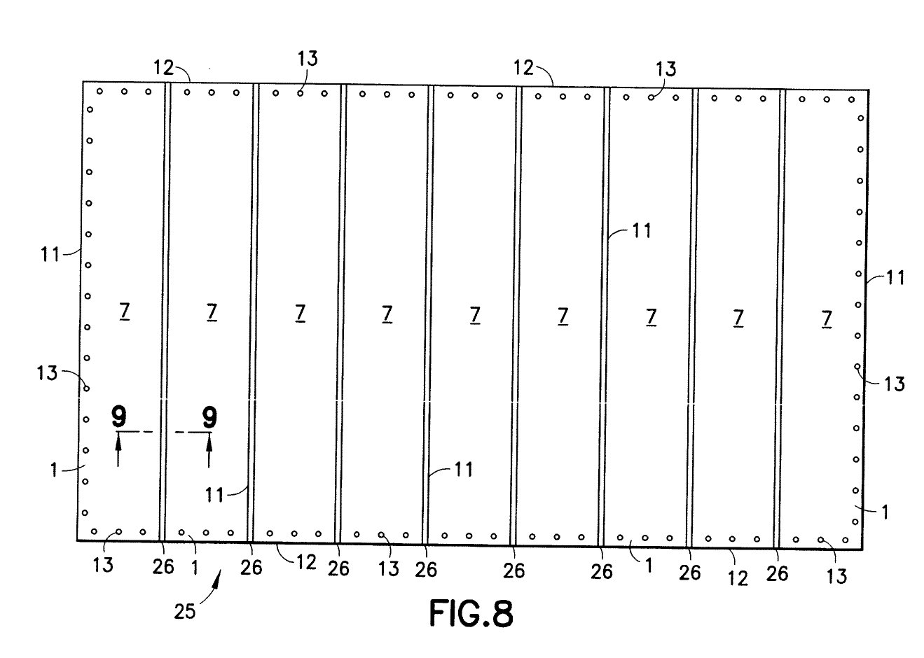

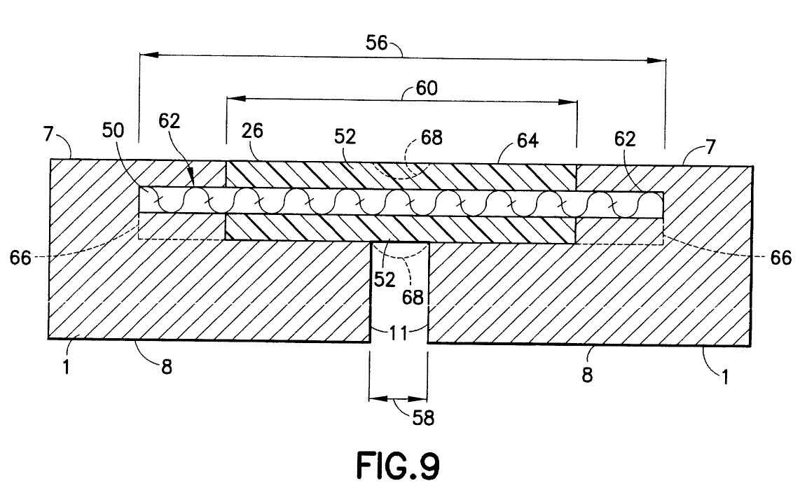

As shown in FIGS. 8 and 9, multiple fiberglass mats 1 can be arranged as a single foldable fiberglass mat 25. The foldable fiberglass mat 25 includes a plurality of hinges 26. Each hinge 26 is disposed between either the first or second pairs of opposing sides 11, 12 of two adjacent fiberglass mats 1 in the foldable fiberglass mat 25 and is secured to both mats 1. For example, the hinges 26 are disposed between the first pairs of opposing sides 11 as shown in FIGS. 8 and 9. Suitable hinges 26 include for example piano-type hinges, strap hinges, and flexible sheet materials such as elastomers. As is shown in FIG. 9, each hinge 26 is for example arranged as a sheet of flexible elastomeric material. This sheet of flexible elastomeric material is of sufficient size and flexibility to permit the adjacent fiberglass mats 1 to be completely folded upon each other as is shown, for example, in FIG. 10. In alternate embodiments, the foldable fiberglass mat assembly may be arranged in any other desired configuration, such as that similar to the arrangement shown in FIG. 4.

In the exemplary embodiment, each hinge 26 includes at least one reinforcement material layer 50, to provide increased strength and longer service life to the hinge. In one embodiment, the reinforcement material may be for example a woven polyester cloth having a weight of about 8.6 ounces per square yard. Each hinge may also include at least one elastomeric material 52 that is applied to at least a portion of the reinforcement material. In one embodiment, the elastomer 52 is applied for example to a central portion 60 of the reinforcement material layer 50, leaving for example a pair of reinforcement material ends 62 that can be used to attach the hinge 26 to the fiberglass mat 1.

In order to facilitate application of the elastomeric material in the exemplary embodiment, the reinforcement material layer 50 is capable of being thoroughly wet out with the elastomer resin. Suitable elastomers include polyester based polyurethanes. For example, the fully cured unreinforced polyester based polyurethane may have a minimum ultimate tensile strength of about 1000 psi and minimum elongation of about 800%. In addition, each hinge 26 may include for example a plurality of aromatic polyamide fibers such as poly para-phenyleneterephthalamide of the amount and type found in the fiberglass layer 2. For example, the plurality of aromatic polyamide fibers may be disposed in the woven polyester cloth reinforcement layer 50.

In the exemplary embodiment, each hinge 26 has a length 54 substantially equal to the length of either the first and second opposing sides of the fiberglass mats depending upon the side to which that hinge 26 is connected. The width 56 of the hinge 26 is selected as desired to minimize the space 58 between adjacent fiberglass mats 1 while still permitting adequate folding and rotation among the fiberglass mats 1 and attachment to the fiberglass mats 1. In the exemplary embodiment, the hinge 26 overlaps each fiberglass mat 1. In one embodiment as illustrated in FIG. 9, each end 62 of the reinforcement material and at least part of the central portion 60 of the hinge 26 may overlap the fiberglass mats 1. This overlap facilitates attachment of the hinges 26 to the fiberglass mats. Suitable methods for attachment of the hinges 26 to the fiberglass mats 1 include for example the use of conventional fasteners and adhesives or bonding agents. For example, each hinge 26 may be directly bonded to the fiberglass layer 2 of each fiberglass mat 1. In this embodiment, each fiberglass mat 1 may have holes 13 along the first or second pairs of opposing sides that are on the perimeter 64 of the foldable fiberglass mat 25 as these holes would not be needed for the attachment of the hinges 26 to the fiberglass mats 1. In order to accommodate the hinge 26 and to align the top surface 64 of the hinges with the top of the mat 7, a cavity 66 may be provided for example along the appropriate side of each fiberglass mat 1. Bonding is achieved by placing or filing the area in the cavity 66 around the hinge 26 and in particular around each end 62 of the reinforcement material with the polyester resin 5. In alternate embodiments, the hinges may be joined to the mats in any other desired manner.

Although the top surface of the hinge 64 is generally aligned with the top surface of the fiberglass mat 7, the hinge may sag or dip in the area where it spans the space 58 between adjacent fiberglass mats 1 as illustrated by the dashed lines 68 in FIG. 9. These dips 68 may be undesirable as they create bumps that pose a hazard to equipment and personnel using the foldable fiberglass mat 25. In order to prevent these dips and also to generally strengthen each hinge, in the exemplary embodiment a thermoplastic material may be added to the hinge 26. The thermoplastic material may be applied to each hinge in an attempt to get up to 100% penetration of thermoplastic into the fibers of the woven polyester cloth reinforcement layer 50. Suitable methods of applying the thermoplastic material include spray processes and pour processes. Any thermoplastic material capable of adding strength to the hinge 26 and of providing a sufficient degree of penetration can be used.

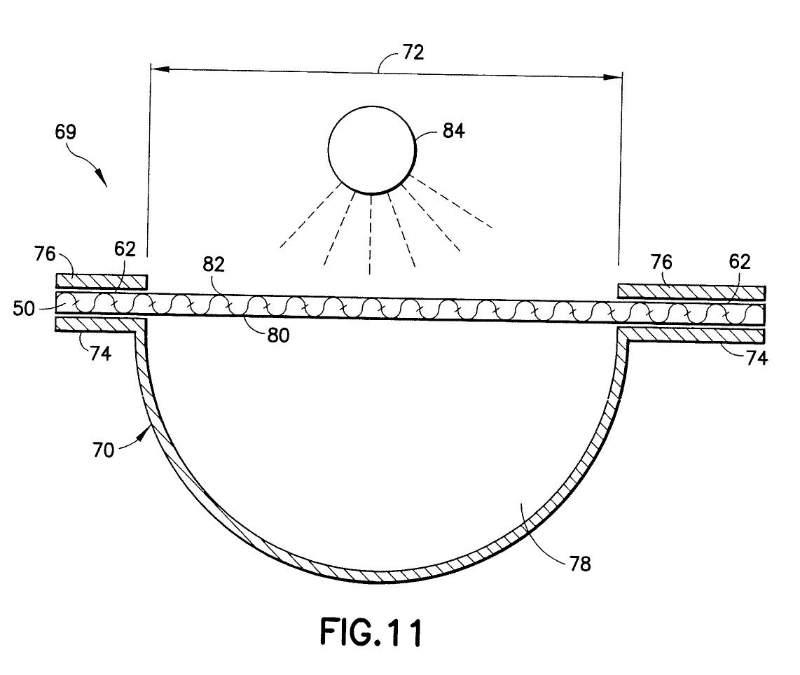

A method and apparatus for making the hinges 26 in accordance with another exemplary embodiment is illustrated in FIG. 11. The apparatus 69 in the exemplary embodiment includes a trough 70, as is shown in cross section shown in FIG. 11. Suitable materials for the trough include aluminum. On either side of the trough opening 72 is a flange 74. The reinforcement material layer 50 is placed in the apparatus so as to rest on the flanges 74 and to span the opening 72. A pair of plates 76 is also provided to hold the material layer 50 in place. Conventional methods such as “C” clamps and spring clamps (not shown) can be used to secure the material layer 50 between each flange 74 and plate 76. For example, the material layer 50 is pulled taut over the opening 72. In one embodiment, the opening 72 is as wide as the central portion 60 of the hinge 26 and each flange 74 is at least as wide as the ends 62 of the reinforcement material layer 50.

In order to coat the reinforcement material layer 50 with the elastomer 52, the interior region 78 of the trough 70 is filled with the elastomer 52. In one embodiment, the elastomer is introduced into the interior region 78 through the opening 72 prior to placing the reinforcement material layer 50 in the apparatus 69. In another embodiment, the elastomer is introduced into the interior region 78 through the end of the trough 70. In this embodiment, the reinforcement material layer 50 may be placed into the apparatus 69 either before or after the elastomer 52 is introduced into the trough 70. A sufficient amount of elastomer is introduced and maintained in the trough 70 so that the elastomer is in contact with a first side 80 of the reinforcement material layer 50. This provides for penetration of the elastomer 52 into the fibers of the reinforcement layer 50. At the same time, the second side 82 of the reinforcement layer opposite the first side 80 is also exposed to the elastomer 52. For example, the elastomer 52 may be introduced to the second side 82 by a spray application process using one or more spray nozzles 84. Conventional spray nozzles and methods of spray applying elastomers are suitable for use with the exemplary embodiment. The elastomer is formulated and the pouring and spraying steps are controlled to achieve the desired thickness and flexibility in the hinge 26.

If thermoplastics are also to be added to the hinge, the elastomer application for example can be followed by the application of the desired thermoplastic. Similar method steps may be followed with the thermoplastic being substituted for the elastomer. Alternatively, the hinge can be assembled into the foldable fiberglass mat first. Following assembly, the thermoplastic material is spray and pour applied to both sides of the hinge areas of the foldable fiberglass mat, providing for penetration not only into the hinge but into the fiberglass mat 1 as well.

The overall size or coverage area of the foldable fiberglass mat 25 is based upon the number, size, and arrangement of the fiberglass mats 1 and hinges 26. In one embodiment, the foldable fiberglass mat 1 for example contains nine fiberglass mat 1 sections and eight hinges. Thus, for example, if each fiberglass mat has a first side length of about 30 feet and a second side length of about 6 feet and the hinges are disposed between adjacent pairs of fiberglass mats and connect the corresponding adjacent first sides, the foldable fiberglass mat 1 measures for example about 30 feet by about 54 feet in an unfolded position and about 30 feet by about 6 feet in the folded position shown in FIG. 10. In this folded position, the foldable fiberglass mat for example has a thickness 27 of about 8 inches up to about 10 inches.

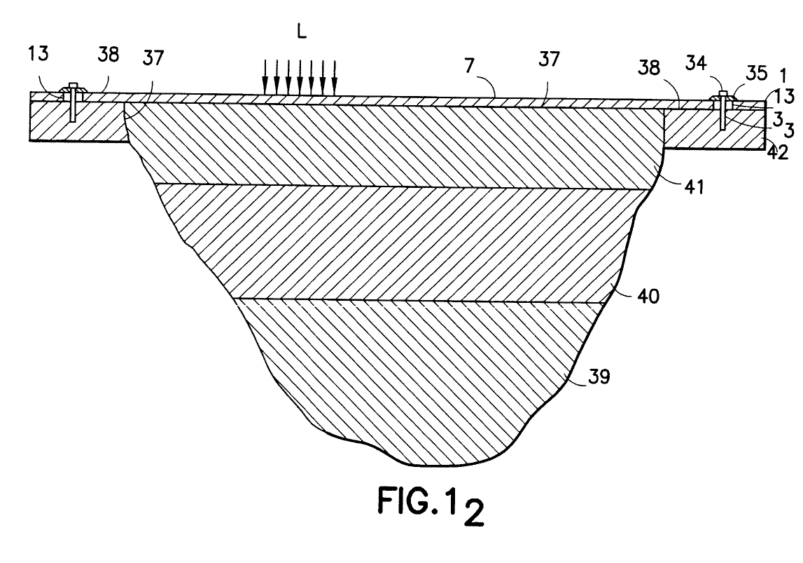

The foldable fiberglass mat 25 can be grouped or arranged into an assembly of foldable fiberglass mats 25. Such an assembly includes at least two of the foldable fiberglass mats connected for example by the same methods and materials used to form an assembly of individual fiberglass mats. For example, each foldable fiberglass mat in the assembly of foldable fiberglass mats may be connected to another foldable fiberglass mat by at least one of the joining panels 16 of the exemplary embodiment. The holes 13 along the perimeter of the foldable fiberglass mat can be used to join multiple fiberglass mats together in the assembly or to anchor the assembly to the ground or other surface. The fiberglass mats are used for the rapid or temporary patching of road surfaces such as cement, asphalt, and macadam surfaces that are either damaged or under repair. For example, the fiberglass mat 1 can be used to repair holes, cracks or depressions in an existing roadway and to provide for a temporary road surface for parking of automobiles or detouring of traffic. In addition, the fiberglass mat and assemblies of fiberglass mats can be used as part of the support for a permanent roadway that is ultimately surfaces with asphalt, macadam or concrete. An example of a typical road repair using the fiberglass mat is shown in cross section in FIG. 12. For example, in order to apply the fiberglass mat 1 as a road patch, the area of the road to be repaired is cleaned of loose or sizeable debris. In addition, the holes or cracks 37 to be repaired my be cut into more regular geometric shapes to more easily fit the size of the fiberglass mat. The area of the road adjacent 38 to the hole or crack 37 is then leveled to remove high spots or depressions. Leveling of the adjacent road 38 area can also be accomplished during reshaping of the hole 37 by cutting out the raised surface areas or by incorporating the depressed road surface adjacent to the hole 37 to be patched. The cleaned and prepared hole 37 is then filled with an assortment of aggregate material in one or more layers.

As illustrated, the hole 37 is filled for example with a layer of backfill debris, ballast rock or stone, or other construction waste 39. In the exemplary embodiment, a layer of aggregate material or crushed stone or a mixture of aggregate material and debris 40 may be placed into the hole 37. Also, the hole may be filled with another layer of aggregate material 41 that typically contains smaller particles or grains than the layer 40 below it. All of the layers are compacted and leveled as the hole is filled with the final layer 41 being leveled to be even with the existing pavement 42. At least one fiberglass mat 1 is then used to cover the aggregate material 41 and is anchored to the road surface. For example, the fiberglass mat is anchored into the existing solid road surface adjacent to the hole or crack 37 to be patched.

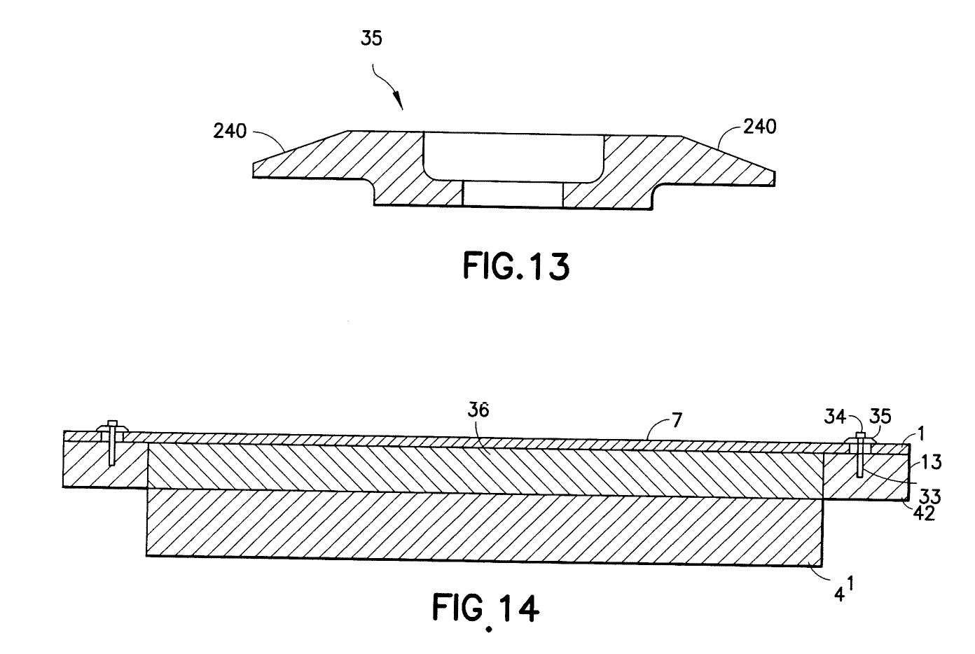

To insure that the fiberglass mat is adequately and securely anchored to the ground or road surface, in the exemplary embodiment anchor holes 33 are drilled in the prepared road surface adjacent to the repair hole in substantial alignment with the desired number of anchor holes 13 in the mat. Fasteners or anchors 34 are then passed through the holes in the mat and into the holes in the landing site, and are secured in place. Suitable anchors include for example spikes, re-bar and anchor bolts. If desired, the anchor 34 may be set in a hardening polymer. Anchor bushings 35 (see also FIG. 13) can be included in the holes 13 to prevent shifting and tearing of the fiberglass mat 1. A suitable anchor bushing 35 is illustrated in FIG. 13 and is generally configured similar to the upper joining bushing 20 (see FIG. 9). As may be realized from FIG. 12, upon completion of the installation of the fiberglass mat over the disrupted road surface, loads L may be applied to the mat. The mat operates to support the loads L and redistributes the loads so that the underlying material is not substantially permanently deformed by the loads L. Accordingly, the restored surface with the fiberglass mat operates as effectively to support desired loads, such as road wheel loads, airplane tire loads or any other structure landed thereon as effectively as the original surface. This allows continued unimpaired use of the road surface.

As illustrated in FIG. 14, additional underlayments or support structures can be added to the compacted aggregate material. Examples of additional underlayments include rigid foams 36. Suitable rigid foams for example may be formulated as expandable liquids that can be poured on or spray applied to the compacted aggregate material or other mounting surface and that expand to the desired volume on the applied surface and harden. The expandability of the foam permits transportation of the foam as a bulk liquid, minimizing transportation and storage needs before deployment as the rigid foam. For example, the foam while in the liquid state, may be moved by conventional pumps, pies, and hoses to the desired point for application. The foam is selected to be able to expand from about 16 up to about 60 times its original volume. Expansion and hardening for example may occur in less than about five minutes, for example from about 3 minutes up to about 4 minutes, and cream times are for example about 1 minute, for example about 55 to about 65 seconds. The hardened rigid foam has for example a density of from about 2 lb/ft³ up to about 15 lb/ft³. For example, the rigid foam has a density from about 2 lb/ft³ to about 6 lb/ft³, for example either 2 lb/ft³, 4 lb/ft³ or 6 lb/ft³ Additional properties of the rigid foams include processability and curability at ambient temperatures, for example from about 50° F. to about 90° F., fire retardancy, expandability in water and resistance to tears and splits during expansion.

Suitable foams include polymeric isocyanate based foams and intumescent foams. Intumescent foams form a self-protecting carbonaceous char when exposed to high temperatures. In one embodiment, the hardening foam may be for example a rigid polyurethane foam (RPF). Suitable RPFs include North Carolina Foam Industries type 911-91 foam, commercially available from North Carolina Foam Industries of Mt. Airy, N.C. This RPF is stored and shipped as a two-part liquid having a first component containing an isocyanate, for example polymeric methylene diphenylene di-isocyanate (PMDI), and a second component containing a polyol resin. The two liquids are mixed for example in approximately a 1:1 ratio by volume just before application to the compacted aggregate material or other mounting surface. For example, the two liquids are mixed in a ratio of 106 parts isocyanate to 100 parts polyol by volume. Any conventional mixer or mixing system capable of adequately mixing the first and second RPF components and of applying the mixed RFP at the rate and thickness desired can be used. An example of a suitable mixer is Decker Model DC80, commercially available from Decker Industries, Port Salerno, Fla. For example, the mixer is equipped with a pressurized solvent flush system to clean the static mixer contained therein.

The RPF is mixed and applied based upon the desired final density or strength of the rigid foam and the final thickness of the foam. The foam can be applied as a single layer of the desired thickness or can be applied as multiple layers to establish the desired thickness. The liquid RPF can be applied to a larger area on dry land or in water, applied to small holes or craters in existing roadways, runways, rigid foams or fiberglass mats. When applied to the ground or land, the area to which the foam is to be applied can be rough graded before application of the foam. In one embodiment, the ground is excavated to a depth approximately equal to the depth of the expanded rigid foam. Therefore, the ground acts as a form to support and shape the expanding foam, and the foam upon expansion is level with the surrounding ground, eliminating the need for additional grading or ramping. In addition, the RPF can be prefabricated into standard size blocks. The prefabricated blocks can be formed by delivering the liquid foam into a suitable container and having the foam expand inside the container. In addition, the RPF can be top coated to smooth out any imperfections or bumps using a topcoat material (not shown), for example a self-leveling elastomer.

In addition to being applied as a temporary or rapidly deployed road surface patch, the fiberglass mat and assemblies of fiberglass mats as illustrated in FIGS. 12 and 14 are used as a support or underlayment for a permanent roadway, highway or parking lot. In the exemplary embodiment, the applied and anchored fiberglass mat 1 may be covered with an overlay of a permanent covering or load-bearing surface. Suitable surfaces include for example asphalt, macadam and concrete. The fiberglass mat provides the desired support and site preparation for the top surface without necessitating as much site preparation or use of foundation materials such as crushed stone. The fiberglass mat of the exemplary embodiment provides California Bearing Ratio of about 273.7 (fiberglass mat over sandy soil) and about 51.9 (fiberglass mat over clay soil). In other embodiments, the fiberglass mats may be arranged and installed as cladding for support. Surfaces of structures such as permanent or temporary roadways, parking lots, etc. As will be described in greater detail below.

The fiberglass mat, foldable fiberglass mat, and assemblies of these mats may be sized, shaped, combined and attached together as a system to form any size or shape three dimensional structure or shelter desired. The mats may be arranged so that the structure may be formed from a single foldable fiberglass mat, or an assembly of fiberglass mats can be secured together with fasteners and joining panels. The mats, foldable fiberglass mats may be joined or connected together to form the desired structure. In alternate embodiments, the mats, foldable mats may be joined or connected in sub-assembly sections or modules of the structure, and the formed sub-assemblies may be connected to each other to assemble the desired structure. In addition, the fiberglass mats, foldable fiberglass mats, and assemblies of these mats can be arranged to provide for a modular structure or shelter system. In one embodiment, the fiberglass mat or foldable fiberglass mat of the exemplary embodiment is used as a drape over existing structures or persons to provide protection from the elements or to act as ballistic shield.

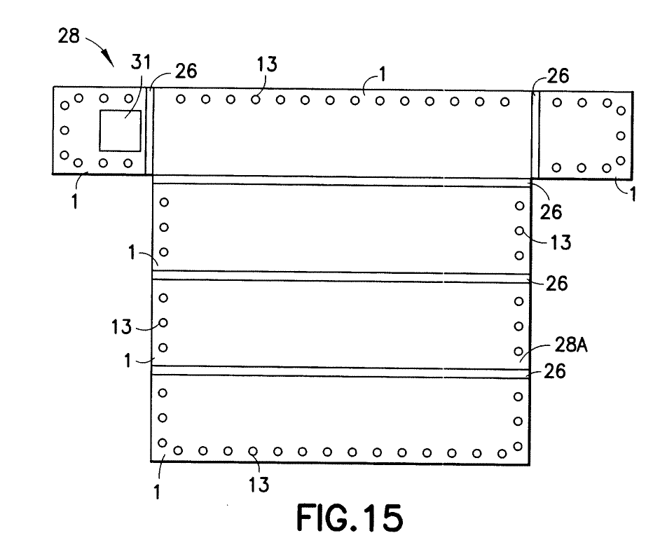

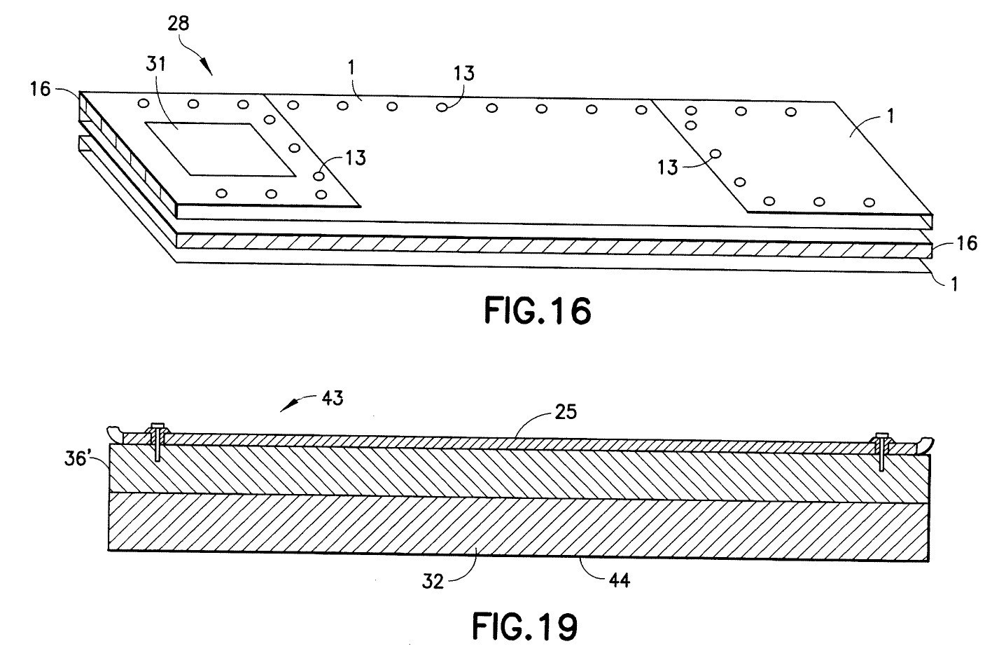

In another exemplary embodiment of the structure system, the fiberglass mats 1, joining panels 16, and flexible hinges 26 are arranged and configured to make a portable, temporary, collapsible structure for use for example in emergency and disaster relief or any other situations where a portable easy to put up and take down structure is desired. As shown in FIG. 15 in an unfolded and unassembled position, the structure, which may be for example a temporary shelter 28, is constructed from an assembly of fiberglass mats 1 and flexible hinges 26, that is as a single foldable fiberglass mat 28A. Alternatively, joining panels 16 can be substituted for the hinges 26. The resulting shelter may be more rigid and permanent. The mats 1 are sized, shaped, and connected with hinges 26 depending upon the desired shape and size of the fully erected structure 28. The structure 28 may be folded for transportation and storage is shown in FIG. 16.

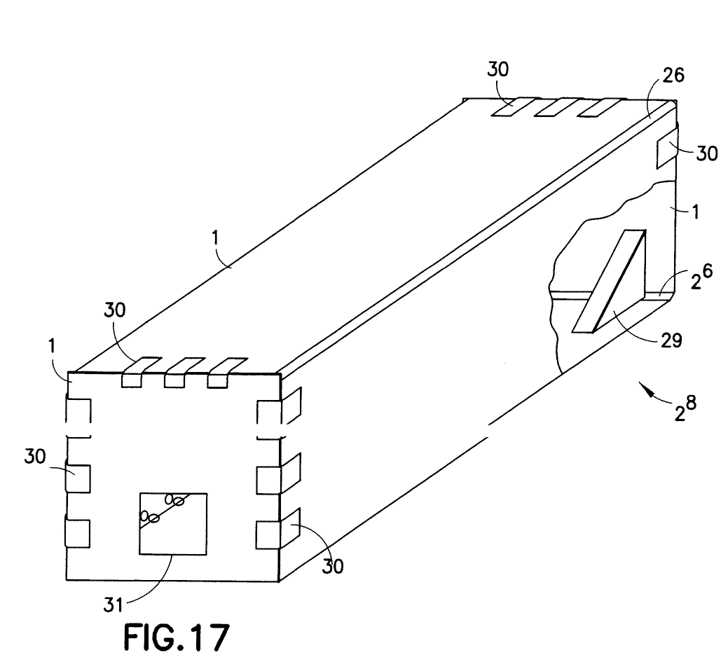

Although the structure 28 can be configured in numerous shapes and sizes, a rectangular box is illustrated (for example purposes only) and is shown fully erected in FIG. 17. In this exemplary embodiment the structure 28 may include a plurality of removable gussets or stiffeners 29 as desired to provide rigidity and retention to the structure 28 in the assembled position. The stiffeners 28 illustrated for example as installed at joints or corners to enhance stability of the structure 28 when assembled, may be made of any suitable materials such as metal, plastic or other non-metallic materials or fiberglass. The stiffeners may have any suitable shape and may be attached in any suitable manner, for example via holes 13 (see FIGS. 15-16). In alternate embodiments, the stiffeners may be integrated into the mats, such as a folding flap of either fiberglass mat or other material that is deployed when the structure is erected.

In the exemplary embodiment, one or more latches 30 (seen best in FIG. 17) are attached to the fiberglass mats 1 to secure the structure 28 in the assembled position. Examples of suitable latches 30 include plastic or metal hinges or straps. In the exemplary embodiment, the latches 30 may be connected to the fiberglass mats 1 at the holes 13. In the exemplary embodiment, at least one of the fiberglass mats 1 includes an opening 31 that may be an access door for users and/or equipment. When the plurality of aromatic polyamide fibers is included in the fiberglass mat 1 or hinges 26, the structure 28 may act as a ballistic shield to protect persons, structures and equipment. Multiple structures 28 may be joined together to form larger structures in a modular arrangement. Joining for modular arrangement can be accomplished through the use of the joining panels 16 as described previously.

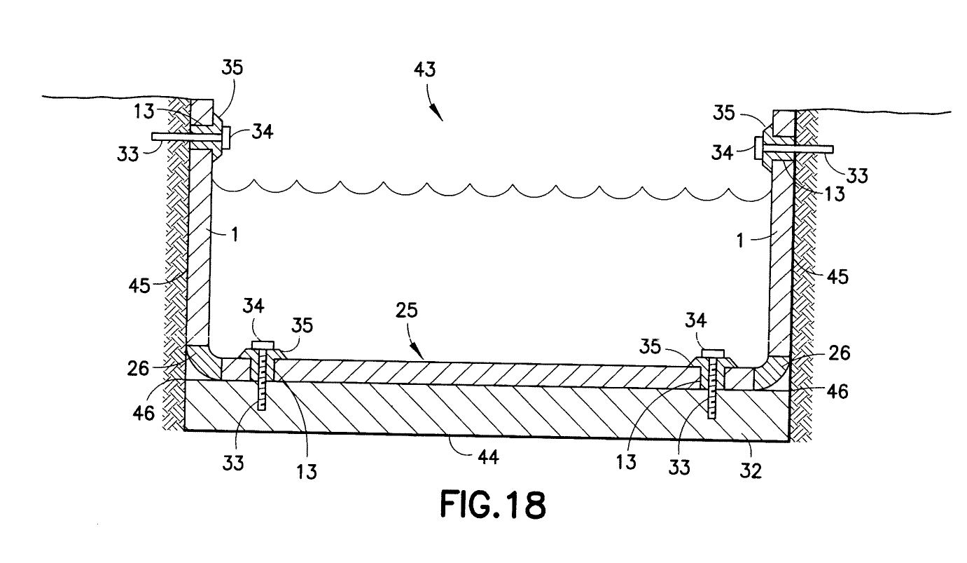

In accordance with yet another exemplary embodiment, the system having the fiberglass mat 1 and assemblies of the fiberglass mat (e.g. foldable or fixed mat assemblies) may be used for the rapid, temporary, semi-permanent or permanent constructions of canals or other conduit like structures. A cross section or a typical canal structure containing a foldable fiberglass mat 25 is illustrated in FIG. 18. In order for installation of the fiberglass mat 1 for the construction of canals in the exemplary embodiment, a canal structure 43 is prepared for example by excavating an area to create a canal bottom 44 and at least two canal sides 45. At least the canal bottom 44 may be lined with an aggregate material 32, although aggregate material 32 can be applied to the sides of the canal structure as well. The aggregate material 32 is then leveled, compacted and smoothed as desired. The prepared canal structure 43 is then lined with a plurality of fiberglass mats 1 or a plurality of foldable fiberglass mats 25. For example, the canal structure may be lined with a plurality of single fiberglass mats 1, or the canal structure may be lined or covered with a plurality of foldable fiberglass mats 25, as shown, for example, in FIG. 18. The mats may be joined together into a single integral structure. Suitable methods for fixedly connecting adjacent pairs of fiberglass mats include using a plurality joining panels. When foldable fiberglass mats are used, they may be conformed to the canal structure for example by aligning the hinges 26 with corners or joints 46 between the canal bottom 44 and the canal sides 45. Once applied, the fiberglass mats are anchored to the canal structure 43.

To ensure that the fiberglass mat is adequately anchored to the canal bottom 44 and sides, a plurality of anchor holes 33 may be formed (such as by drilling) in the bottom 44, sides 45, of aggregate material 32 in alignment with desired anchor holes 13 in the mat. Fasteners or anchors 34 are then passed through the holes in the mat and into the holes 33 and are secured in place. Examples of suitable anchors include spikes, re-bar and anchor bolts. If desired, the anchor 34 may be set in a hardening polymer. Anchor bushings 35 (see FIG. 13) can be included in the holes 13 to prevent shifting and tearing of the fiberglass mat 1 if desired. The anchor bushing 35 may be generally configured similar to the upper joining bushing 20 (see FIG. 7). In alternate embodiments, the mats may be secured to the backing material in any other suitable manner. In other alternate embodiments, individual fiberglass mats, or nonfoldable mat assemblies may be positioned in the excavated channel to respectively cover each of the side channels thus forming retaining walls for the channel structure. A liner or other suitable generally impermeable flexible layer may be disposed against fiberglass mats assembled to form the channel structure to form the inside surface of the channel.

As illustrated in FIG. 19, additional layers or support structures may be added to the compacted aggregate material. As noted before, suitable additional layers may for example include hardening foams 36 (similar to foams 36 see FIG. 14). Suitable rigid foams may be for example formulated as expandable liquids that can be poured on or spray applied to the compacted aggregate material or other mounting surface and that expand to the desired volume on the applied surface and harden as also described previously. Expansion and hardening for example may occur in less than about five minutes, and cream times are for example about 1 minute, generally about 55 to about 65 seconds. The hardened rigid foam for example has a density of from about 2 lb/ft³ up to about 15 lb/ft³. For example, the rigid foam has a density from about 2 lb/ft³ to about 6 lb/ft³. Such as either 2 lb/ft³, 4 lb/ft³, or 6 lb/ft³. Additional properties of the rigid foams include processability and curability at ambient temperatures, for example from about 50° F. to about 90° F., fire retardancy, expandability in water and resistance to tears and splits during expansion.

As noted previously, suitable foams include polymeric isocyanaic based foams and intumescent foams. In one embodiment, the hardening foam may be a rigid polyurethane foam (RPF). Suitable RPFs include North Carolina Foam Industries type 911-91 foam, commercially available from North Carolina Foam Industries of Mt. Airy, N.C. Any conventional mixer or mixing system capable of adequately mixing the first and second RPF components and of applying the mixed RPF at the rate and thickness desired can be used. An example of a suitable mixer is Decker Model DC80, commercially available from Decker Industries, Port Salerno, Fla. For example, the mixer may be equipped with a pressurized solvent flush system to clean the static mixer contained therein.

The RPF is mixed and applied based upon the desired final density or strength of the rigid foam and the final thickness of the foam. The foam can be applied as a single layer of the desired thickness or can be applied as multiple layers to establish the desired thickness. In the exemplary embodiment, the liquid RPF can be applied to the channel structure 45 (see FIG. 18) dry or in water. In one embodiment, the ground is excavated to a depth approximately equal to the depth of the expanded rigid foam. Therefore, the ground acts as a form to support and shape the expanding foam, and the foam upon expansion is level with the surrounding ground, eliminating additional grading or ramping. In alternate embodiments, the RPF may be installed as prefabricated blocks of desired size. The prefabricated blocks can be formed by delivering the liquid foam into a suitable container and having the foam expand inside the container. In addition, the RPF can be top coated to smooth out any imperfections or bumps using a topcoat material (not shown).

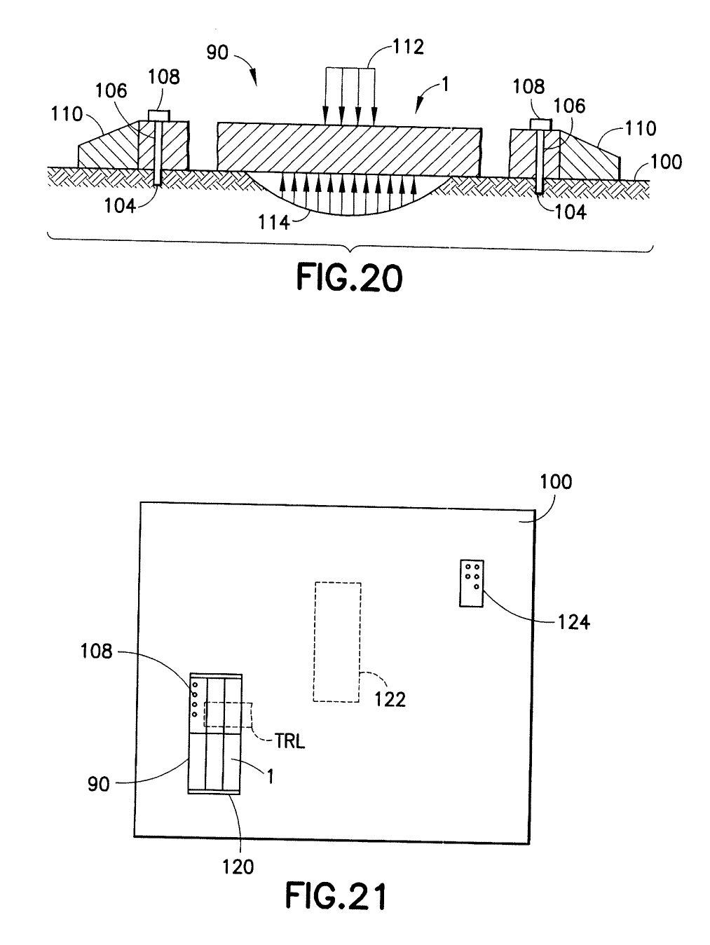

Referring now to FIG. 20, there is shown a cross-section of fiberglass mat 1 deployed as cladding or armor for a base-supporting surface 100. In the exemplary embodiment supporting surface 100 may be generally a ground surface, a road surface, a paved or concrete, cement, asphalt, or macadam lot surface, or an unpaved surface used to support a load, for example from trucks, aircraft or otherwise. The supporting surface 100 is representatively shown in FIG. 20 as being a ground surface, in alternate embodiments the base support surface may be elevated off the ground, such as having the base support surface defined by an elevated structure, for example an overpass, bridge, ramp, floors of multi-storied structures, etc. In other alternate embodiments, mat 1 may be deployed as cladding for any suitable surface or load. In the exemplary embodiment shown here, the fiberglass mats 1 may be used to build up and reinforce base surface 100, for example, where a point or distributed load 112 applied to mat 1 may exceed the tolerable or desired bearing load for surface 100. Mat 1 distributes load 112 more evenly, for example in pattern 114, across surface 100 eliminating the potential for impressions or damage to the base surface. For example, surfaces of parking areas for heavy load transport, such as parking areas, or loading areas for trucks and/or trailers may be routinely subjected to high local loads such as from the landing structure of trailers, or even truck tires, for some extended time resulting in undesired permanent deformation and damage to the support surface. The cumulative effect of such damage is rapidly increasing deterioration of the support surface possibly rendering it unusable without ripout and resurfacing. Referring now also to FIG. 21, in the exemplary embodiment cladding layer 90 (formed from one or more mats 1 as will be described below) may distribute a bearing load applied to an area 112 of the top surface 100 of the movable cladding layer over a larger area 114 of the supporting surface 100. Ramps 110 may be provided at the edges of cladding layer 90 to facilitate loading and unloading of the cladding surface. In the embodiment shown, cladding layer 90 provides a build up or reinforcement of surface 100 that distributes loads.

In the exemplary embodiment, the cladding layer 90 may be modular and movable. The cladding layer may be removably installed on the base surface as will be described below. In alternate embodiments the cladding layer may be permanently attached to the base support surface. In the exemplary embodiment, at least one fiberglass mat 1 may be used to cover and clad surface 100 and may be anchored to surface 100. In alternate embodiments, additional mats 1 and/or ramps 110 may be connected together in any suitable shape to reinforce and clad a portion or all of surface 100. Accordingly, in the exemplary embodiment, the cladding 90 arranged on base surface 100 may have a selectably variable size and shape (the shape of the cladding shown in FIG. 21 is merely exemplary.) The location of the cladding on the base surface may also be selected as desired. For example, the cladding may be positioned in way of support structure loads of a trailer or in way of tire loads of truck/trailer (a representative loading structure TRL, such as a trailer, is shown in FIG. 21 disposed over the cladding for example purposes). The cladding may be continuously distributed or separately distributed as desired. To insure that fiberglass mat 1 is adequately and securely anchored to the base surface 100, a plurality of anchor holes 104 may be drilled in surface 100 adjacent in alignment with a plurality of anchor holes 106 in mat 1. Fasteners or anchors 108 may secure mat 1 in place, for example, similarly to that described before and shown in FIG. 12. Although suitable anchors include spikes, re-bar and anchor bolts and bushings as described, any suitable anchor or fastener may be provided. In the embodiment shown, the relocatable ground cladding system 90 has a movable cladding layer having at least one interconnectable fiberglass mat 1 as previously described, with the movable cladding layer being supported by the supporting surface 100 at a given location. Fasteners 108 may be removable fasteners, for example Hilty type bolts, provided coupling the movable cladding layer to the supporting surface 100 through holes 106, preventing motion of the cladding 1 relative to surface 100 as loads are applied from multiple directions. Here, the removable fasteners 108 are removably fastened to the supporting surface 100 via holes or inserts 104 in surface 100.

Referring still to FIG. 21, there is shown a top view of fiberglass mat(s) 1 deployed as cladding 90 for base supporting surface 100. In the embodiment shown, movable cladding layer 90 may be moved from a first location 120 to a second location on the supporting surface. For example, if a change in loading locations on surface 100 is desired, such as when a new loading bay is desired, the cladding may be removed from one installation location and relocated to the different desired location on support surface 100. For example, fasteners 108 may be removed, holes or features drilled into surface 100 at location 122 and the cladding 90 relocated as shown. Hence, cladding 90 acts as a cladding like support surface for surface 100 where surface 100 may be, for example, a permanent parking lot or roadway or any interior or exterior ground slabs or surface as noted before. The surface 100 may be a prepared surface of any desired material type, for example, asphalt, macadam or concrete. In alternate embodiments, cladding 90 or mats 1 may also be applied over unprepared surfaces, for example flat ground in order to form a pad upon which loads may be applied. As noted before, cladding 90 may be useful where loads to be applied to the surface 100 exceed design or allowable surface bearing loads or where loads to be applied to surface 100 would over time deform or otherwise degrade surface 100.

For example, as has also been noted before cladding 90 may be used where surface 100 may apply to the parking areas of a truck stop or truck trailer depot. Here, cladding 90 may be installed as single or multiple mats 1 where loaded trailers or cabs may be parked. For example, trailer support gear wheels are lowered to allow the cab to be decoupled from the trailer. The loads applied to surface 100 from the landing/support gear loads may exceed allowable bearing loads, thus causing cracks in concrete or dimples and surface deformation in asphalt or macadam. This damage is particularly apparent over prolonged periods of support in the same position. Here, single or multiple mats 1 may be installed individually or coupled together (as previously described) as cladding 90 on base surface 100 in areas where tires/support gear of trailers is expected. As previously described, the mats act to distribute loads so that bearing loads on permanent surface 100 are sufficiently low to prevent damage to permanent surface 100. As previously described, the mats may be connected together and may be arranged in foldout sections and attached to the ground surface 100 in a manner similar to that described in FIGS. 12 and 13. In alternate embodiments, any suitable fastening methods may be provided. In alternate embodiments, any suitable number of cladding 90 in any suitable shape(s) may be provided to effectively protect surface 100. In the embodiment shown, cladding 90 is installable to suit and as desired in any suitable location. Additionally, cladding 90 may be removable and relocatable to different locations on the same surface or to a different surface in order to suit changing needs. Cladding 90 may be installed over a new surface or an old and/or damaged surface either with repair, for example as previously described or without repair. Here, cladding may be installed and configured over a fresh and undamaged surface to protect the surface and may also be reconfigurable once installed, whereby cladding 90 can be removed and reinstalled in different configuration, for example cladding 90 may be capable of being shifted from a first position 120 to a different position 122 or positions 122, 124 with a different shape 124 or different configuration 124. Here, mat(s) are shown used as cladding 90 to cover at least a portion of ground surface 100 and to support any kind of suitable structure and/or load that may be landed, placed or rolled into the mats 90 while distributing the loads safely over surface 100.

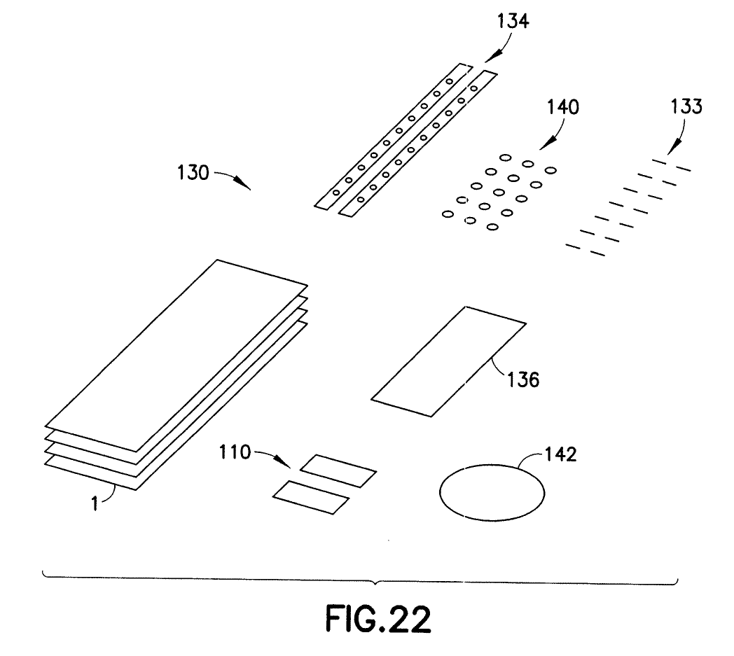

Referring now to FIG. 22, there is shown a schematic isometric view of a kit 130 having fiberglass mat for deployment as cladding for a supporting surface. Kit 130 may be provided with multiple mats of same and/or different size, installation fasteners and tools allowing installation of any suitable arrangement. In alternate embodiments, kit 130 may have more or less mats or suitable fasteners or modules. Kit 130 is shown with a stacked election of rectangular mats 1. Fastener bars 134 are provided to couple mats 1, one to the other in any suitable combination. In alternate embodiments, mats 1 may be foldable relative to each other and laid flat as previously described. A selection of ramps 110 may also be provided and fastenable to mats 1. Alternate sized mats, for example mats 136, 142 may be provided in any suitable numbers or combinations to allow the user flexibility in populating a given site with mats or cladding. Fasteners 138 and 140 may also be provided to allow for removable or permanent fastening of the cladding. Although not shown, any additional suitable items may be provided in the kit, for example, equipment to store, move, relocate and install the cladding.

It should be understood that the foregoing description is only illustrative of the invention. Various alternatives and modifications can be devised by those skilled in the art without departing from the invention. Accordingly, the exemplary embodiment is intended to embrace all such alternatives, modifications and variances, which fall within the scope of the appended claims.

What is claimed is:

1. A portable ground matting system comprising:
at least one fiberglass mat having a fiberglass layer with at least one roving and a resin disposed on the at least one roving; and
at least one fastener for removably fastening the at least one fiberglass mat to a ground surface so that the at least one fiberglass mat mats the ground surface;
wherein, when loads are disposed on the matted ground surface so that the loads load the at least one fiberglass mat, the at least one fiberglass mat operates between the loads and ground surface to redistribute the loads to the ground surface to prevent substantial permanent deformation of the ground surface.

2. A method for the rapid repair of road surfaces comprising:
preparing an area of a road surface to be repaired;
covering the prepared area with the portable ground matting system of claim 1.

3. The system of claim 1, wherein the at least one fiberglass mat comprises:
a fiberglass layer comprising:
a first woven roving;
a second woven roving spaced from the first woven roving; and
a polyester resin to saturate the first and second woven rovings and to fill the space between the first and second woven.

4. The system of claim 3, wherein the fiberglass mat further comprises a reinforcement layer attached to the fiberglass layer to prevent shifting of the fiberglass mat and to minimize shifting and erosion of the area under the fiberglass mat.

5. The system of claim 4, wherein the reinforcement layer comprises a resin-impregnated, semi-rigid, open grid of continuous multi-filament reinforcing strands.

6. The system of claim 3, wherein the at least one fiberglass mat further comprises a plurality of aromatic polyamide fibers.

7. The system of claim 6, wherein the aromatic polyamide is polyparaphenyleneterephthalamide.

8. The system of claim 6, wherein the aromatic polyamide fibers are disposed in at least one of the first and second woven rovings.

9. The system of claim 3, wherein: the at least one fiberglass mat comprises a plurality of holes passing completely through the mat.

10. The system of claim 1, wherein the at least one fastener is an anchor fastener.

11. The system of claim 1, wherein the at least one fiberglass mat comprises a number of foldable fiberglass mat sections.

12. The method of claim 2, wherein covering comprises unfolding the at least one fiberglass mat.

13. A relocatable ground cladding system adapted to cover and at least partially clad a supporting ground surface, the system comprising:
a movable structural cladding layer having at least one fiberglass mat; and
removable fasteners coupling the movable structural cladding layer to the supporting ground surface, the removable fasteners being removably fastened to the supporting ground surface to removably couple the movable structural cladding layer to the supporting ground surface so that the movable structural cladding layer clads the supporting ground surface at a first location.

14. The system according to claim 13, wherein the movable structural cladding layer is movable from the first location to a second location on the supporting ground surface in which the movable structural cladding layer can be coupled to the supporting ground surface to clad the supporting ground surface.

15. The system according to claim 13, wherein the movable structural cladding layer is adapted to distribute a bearing load applied to an area of the top surface of the movable cladding layer over a larger area of the supporting surface.

16. The system according to claim 13, wherein the at least one fiberglass mat comprises a number of interconnectable fiberglass mats.

17. A portable shelter comprising a foldable fiberglass mat comprising:
a plurality of fiberglass mat sections;
a plurality of hinges connected to the mat sections, each hinge, disposed between two adjacent fiberglass mat sections to form a single foldable shelter;
a folded position for use in storing and shipping the shelter; and
an expanded position for storage and protection of objects or person placed within the shelter.

18. The shelter of claim 17, wherein each fiberglass mat section comprises:
a fiberglass layer; and
a reinforcement layer attached to the fiberglass layer sufficient to provide structural support rigidity to the shelter;

19. The shelter of 18, wherein the reinforcement layer comprises a glass grid.

20. The shelter of claim 18, wherein the fiberglass layer comprises:
a first woven roving;
a second woven roving spaced from the first woven roving; and
a polyester resin to saturate the first and second woven rovings and to fill the space between the first and second woven rovings.
